(19) United States
(12) Patent Application Publication
(10) Pub. No.: US 2015/0288291 A1
(43) Pub. Date: Oct. 8, 2015

(54) SOLAR PHOTOVOLTAIC POWER CONVERSION APPARATUS

(71) Applicants: SAMSUNG SDI CO., LTD., Yongin-si (KR); INDUSTRY FOUNDATION OF CHONNAM NATIONAL UNIVERSITY, Gwangju (KR)

(72) Inventors: Sang-Taek HAN, Yongin-si (KR); Jung-Pil PARK, Yongin-si (KR); Tetsuhiro ISHIKAWA, Yongin-si (KR); Sung-Jun PARK, Gwangju (KR)

(21) Appl. No.: 14/678,332

(22) Filed: Apr. 3, 2015

(30) Foreign Application Priority Data
Apr. 4, 2014 (KR) 10-2014-0040815

(51) Int. Cl. H02M 3/335

(52) U.S. Cl. CPC H02M 3/33546

(57) ABSTRACT

A power conversion apparatus includes a full bridge switching circuit coupled to a solar panel, a transformer to convert a voltage from the full bridge switching circuit, a diode rectifier coupled to the transformer, and a boost converter coupled to the diode rectifier. The boost converter performs maximum power point tracking of the solar panel. The duty ratio of the full bridge switching circuit is adjusted to be substantially 0.5.

### CROSS-REFERENCE TO RELATED APPLICATION

Korean Patent Application No. 10-2014-0040815, filed on Apr. 4, 2014, and entitled, “Solar Photovoltaic Power Conversion Apparatus,” is incorporated by reference herein in its entirety.

### BACKGROUND

1. Field

One or more embodiments described herein relate to a solar photovoltaic power conversion apparatus.

2. Description of the Related Art

A variety of power generating methods have been developed. Examples include resource exhaustion, thermal power generation, and nuclear power generation. These types of power generating methods have environmental and safety issues which make them less desirable for some applications. Recently, research has been actively conducted on various forms of renewable energy sources, including solar photovoltaic power generation.

Solar energy generation does not produce pollutants and therefore is considered to be a clean energy source. As a result, solar energy generation may be widely applied in residential and vehicle applications, as well as for streetlights, light houses, and communication devices.

A solar power system may be considered to generate maximum power at the maximum power point. This point may correspond to a maximum intersecting point of corresponding power and voltage in a power-voltage characteristic curve of a solar cell. However, the power generated by a solar power system may vary depending on the surrounding environment, e.g., the strength of sunlight, temperature, clouds, etc.

Therefore, it may be beneficial to maintain an operating point of the solar power system (e.g., an operating point of a solar cell) at a maximum power point (MPP), which is a maximum output power of the solar cell, such that the maximum power may be maintained given conditions of the surrounding environment.

### SUMMARY

In accordance with one embodiment, a power conversion apparatus includes a full bridge switching circuit coupled to a solar panel; a transformer to convert a voltage from the full bridge switching circuit; a diode rectifier coupled to the transformer; and a boost converter coupled to the diode rectifier, the boost converter to perform maximum power point tracking of the solar panel, wherein a duty ratio of the full bridge switching circuit is adjusted to be substantially 0.5.

The full bridge switching circuit may include a first switch coupled between a first output terminal of the solar panel and a first node; a third switch coupled between the first node and a second output terminal of the solar panel; a fourth switch coupled between the second output terminal of the solar panel and a second node; and a second switch coupled between the second node and the second output terminal of the solar panel.

The diode rectifier may include a first diode coupled between a converter access node and a third node; a third diode coupled between the third node and a common node; a fourth diode coupled between the converter access node and a fourth node; a second diode coupled between the fourth node and the common node.

The transformer may include a first coil accessed between the first node and the second node, and a second coil accessed between the third node and the fourth node

The boost converter may include a first inductor coupled between the converter access node and a snubber access node; and a fifth switch coupled between the snubber access node and the common node.

The apparatus may include a snubber circuit coupled to the boost converter. The snubber circuit may include a fifth diode coupled between the snubber access node and an inverter access node; a first capacitor and a first resistance coupled in series between the snubber access node and a sixth node; a sixth diode coupled between the sixth node and the inverter access node; a seventh diode coupled between the snubber access node and a seventh node; and a second capacitor and a second resistance coupled in series between the seventh node and the inverter access node. The snubber circuit may include an eighth diode coupled between the sixth node and the seventh node.

The apparatus may include a direct current link coupled between the inverter access node and the common node. The first switch and the second switch may be simultaneously turned ON/OFF, and the third switch and the fourth switch may be simultaneously turned ON/OFF. The third switch and the fourth switch may be turned OFF when the first switch and the second switch are turned ON, and the third switch and the fourth switch may be turned ON when the first switch and the second switch are turned OFF. A turn ON period for the first switch and the second switch may be substantially equal to a turn ON period for the third switch and the fourth switch.

The fifth switch may be zero voltage turned OFF by the snubber circuit. The apparatus may include an inverter coupled to the DC link. The common node nay be coupled to a reference potential.

The apparatus may include an LLC resonant circuit coupled between the full bridge switching circuit and the transformer. The LLC resonant circuit may include a resonant inductor and a resonant capacitor coupled in series between the first node and an eighth node of the transformer; and a magnetizing inductor coupled between the eighth node and the second node. The diode rectifier may include a third capacitor coupled between the converter access node and the common node.

In accordance with another embodiment, a power conversion apparatus includes a switching circuit coupled to a renewable energy source; a transformer to convert a voltage from the switching circuit; a rectifier to rectify the converted voltage from the transformer; a boost converter coupled to the rectifier and to perform maximum power point tracking of the solar panel; and a capacitor coupled between the boost converter and a power user, wherein a duty ratio of the full bridge switching circuit is adjusted to be a predetermined value. The predetermined value may be substantially 0.5.

### BRIEF DESCRIPTION OF THE DRAWINGS

Features will become apparent to those of skill in the art by describing in detail exemplary embodiments with reference to the attached drawings in which:

FIG. 1 illustrates an example of an insulating MPPT converter;

FIG. 2 illustrates an embodiment of a power conversion apparatus;

FIG. 3 illustrates an embodiment of an MPPT algorithm;

FIG. 4 illustrates an embodiment of a perturbation and observation method;

FIG. 5 illustrates an embodiment of a circuit of a power conversion apparatus; and

FIG. 6 illustrates another embodiment of a circuit of a power conversion apparatus.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

FIG. 2 illustrates an embodiment of a power conversion apparatus which includes a solar panel 10, a full bridge unit 20, a boost converter 30, a snubber circuit part 40, a direct current (DC) link 50, an inverter 60, and an MPPT controller 70.

The solar panel 10 converts solar energy from sunlight into electrical energy and outputs the converted electrical energy. The solar panel 10 may be, for example, a photovoltaic array.

The full bridge unit 20 may be a converter which converts power generated from the solar panel 10 to DC power of a different level. The converted power is transferred to the boost converter 30.

The boost converter 30 tracks an output of the solar panel, which varies in accordance with solar radiation and temperature, transferred from the full bridge unit 20 to a maximum power point (MPP), thereby boosting a DC voltage from the full bridge unit 20 to a predetermined DC output voltage.

The snubber circuit part 40 may be a resonant snubber circuit which enables the boost converter 30 to perform zero current switching (ZCS).

The DC link 50 may temporarily store DC power output from the boost converter 30 for transfer to the inverter 60.

The inverter 60 may convert DC power output from the DC link 50 to alternating current (AC) power. The AC power may be output, for example, to an electric power system 80. The inverter 60 may be implemented, for example, a single phase-, a three phase- or a multi-level inverter.

The electric power system 80 may be an alternating current power system provided by an electric power company or a power generation company. For example, the electric power system 80 may include a power plant, a substation, or a power line, and may be widely formed electrical linkage. In one embodiment, the electric power system 80 may be a grid.

The MPPT controller 70 tracks the MPP of the solar panel 10 using a MPPT control algorithm. In operation, the MPPT controller 70 may adjust a duty ratio D of the boost converter 30 to fix the output voltage of the solar panel 10 to a maximum output voltage Vmax which matches the MPP.

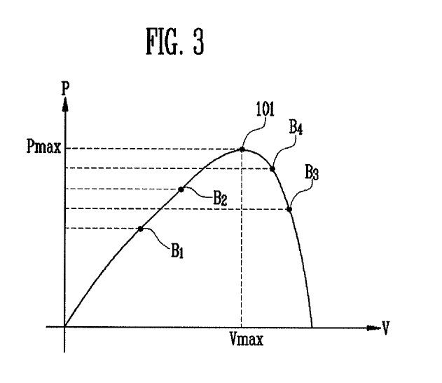

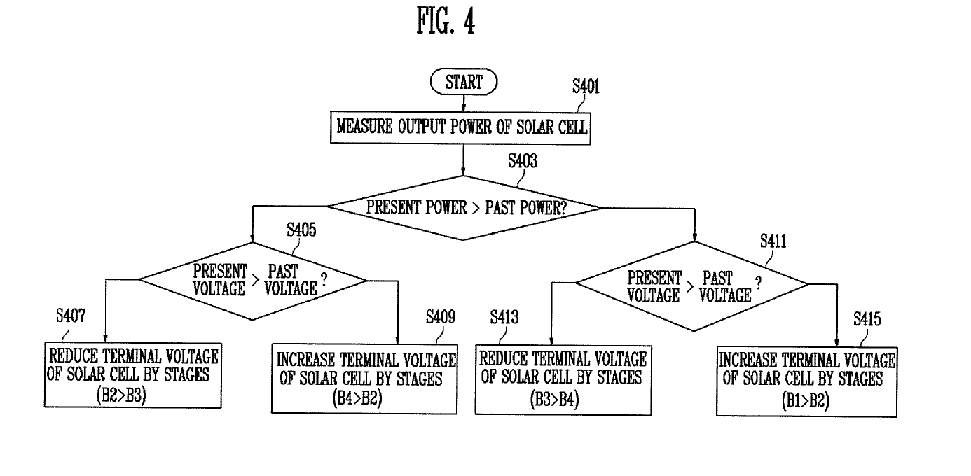

Referring to FIG. 3, for a voltage of the solar panel to be equal to or less than the solar panel voltage Vmax, a voltage gradient may be directly proportional to a power gradient. For a voltage of the solar panel to be equal to or greater than the solar panel voltage Vmax, the voltage gradient may be inversely proportional to the power gradient based on a solar panel voltage Pmax of MPP 101 in a power-voltage (P-V) characteristic curve of the solar panel. Using such a characteristic, the MPPT controller 70 may determine a switch operation for the MPPT by measuring a minor fluctuation difference between a present value and a past value.

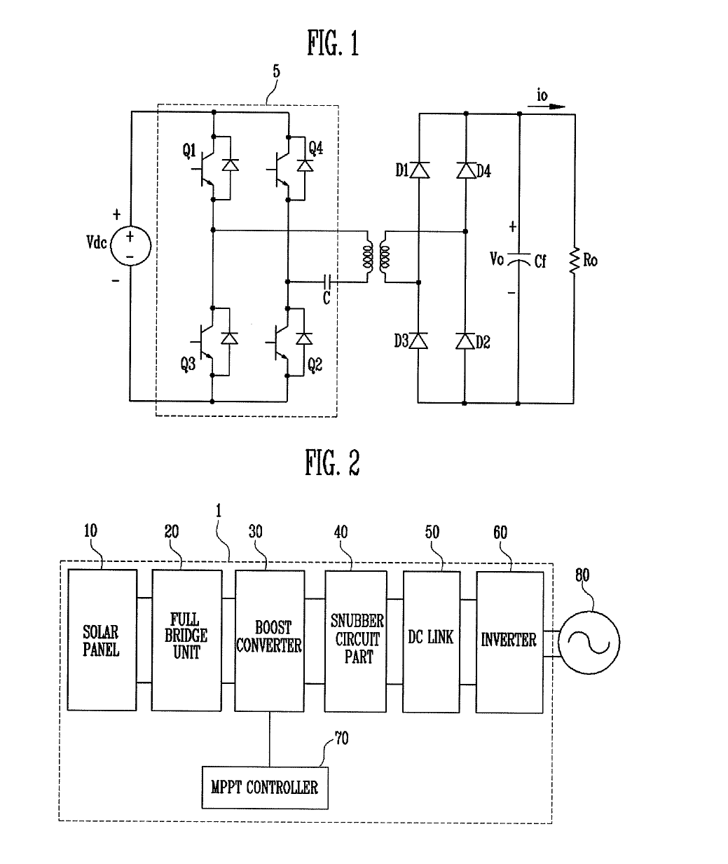

FIG. 1 illustrates an example of one type of insulating MPPT converter. The MPPT converter in FIG. 1 uses a full bridge switching circuit 5. A duty cycle of the switching circuit 5 is changed to control power transfer. As the duty ratio is reduced, a circulating current in the MPPT converter increases, thereby increasing power loss. A representative example of an MPPT control algorithm may be perturbation and observation (P&O) method, which has a simple feedback structure and has a small number of measurement parameters.

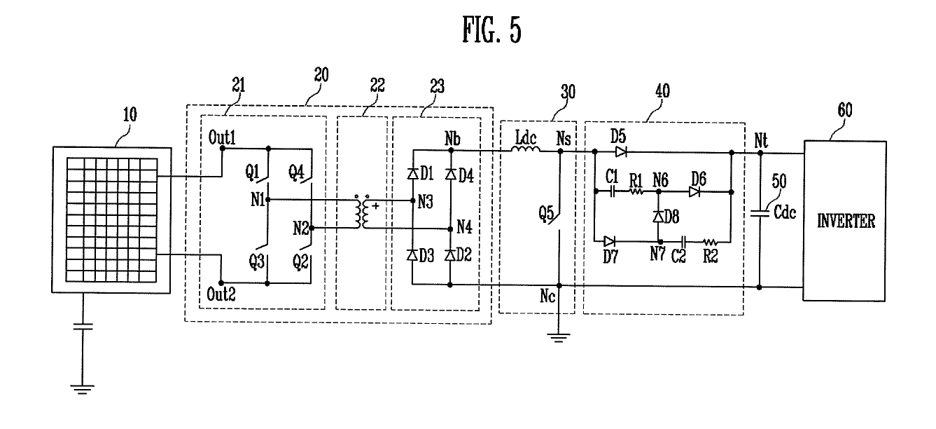

FIG. 4 illustrates operations included in one embodiment of a P&O method used as an MPPT algorithm. The P&O method may operate in a manner that periodically increases or decreases an operating voltage of a solar cell, and may track and find the MPP by comparing past output power and present output power of a solar cell during a disturbed period.

Referring to FIGS. 3 and 4, the method includes measuring the output power of the solar cell (S401). Power measurement may be performed, for example, for every predetermined cycle and/or in response to some predetermined schedule or operation. Present power measured during a present cycle may be compared against past power measured during a past cycle (S403). If the present power is less than the past power, a terminal voltage of the solar cell during the present cycle (the “present voltage”) may be compared against a terminal voltage of the solar cell during the past cycle (the “past voltage”) (S405). If the present voltage is greater than the past voltage, the terminal voltage of the solar cell may be reduced, for example, by a predetermined increment in one or more stages (S407). Operation S407 may be performed to move a power point to B3, for example, when the power point is moved from a point B2 to the point B3, close to a MPP 101 in a P-V characteristic curve in FIG. 3.

When the present voltage of the solar cell is less than the past voltage in S411, the terminal voltage of the solar cell may be increased by the predetermined increment in one or more stages (S415). Operation S415 may be performed to move the power point to B2, for example, when the power point is moved from a point B1 to the point B2, close to the MPP 101 in the P-V characteristic curve in FIG. 3.

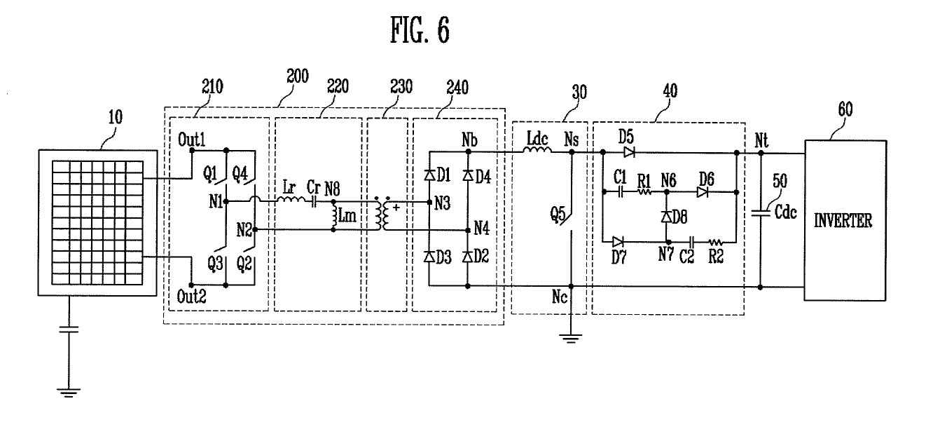

FIG. 5 illustrates an embodiment of a circuit of a power conversion apparatus. Referring to FIG. 5, a full bridge unit 20, a transformer 22, and a diode rectifier 23. The full bridge unit 20 may include a full bridge switching unit 21 coupled to a solar panel. The transformer 22 converts a voltage from the full bridge switching unit 21 and outputs the converted voltage. The diode rectifier 23 is coupled to the transformer 22.

The full bridge switching unit 21 may supply DC power input from the solar panel to the transformer 22. The full bridge switching unit 21 may supply the DC power so as to allow a current to flow alternatively in both directions of a coil on an input side of the transformer 22.

The full bridge switching unit 21 may also include a first switch Q1 coupled between a first output terminal Out1 of the solar panel and a first node N1, a third switch Q3 coupled between the first node N1 and a second output terminal Out2 of the solar panel, a fourth switch Q4 coupled between the second output terminal Out2 of the solar panel and a second node N2, and a second switch Q2 coupled between the second node N2 and the second output terminal OUT2 of the solar panel.

The transformer 22 may boost the input DC voltage and may include a first coil and a second coil having a turn ratio of a. The first coil may be accessed between the first node N1 and the second node N2. The second coil may be accessed between the third node N3 and the fourth node N4.

The diode rectifier 23 may rectify boost power supply which is boosted at the transformer 22. The diode rectifier 23 may include a first diode D1 coupled between a converter access node Nb and a third node N3, a third diode D3 coupled between the third node N3 and a common node Nc, a fourth diode D4 coupled between the converter access node Nb and a fourth node N4, and a second diode D2 coupled between the fourth node N4 and the common node Nc. The common node Nc may be coupled to a reference potential, e.g., ground.

The first diode D1 may have an anode coupled to the third node N3 and a cathode coupled to the converter access node. The second diode D2 may have an anode coupled to the common node Nc and a cathode coupled to the fourth node N4. The third diode D3 may have an anode coupled to the common node Nc and a cathode coupled to the third node N3. The fourth diode D2 may have an anode coupled to the fourth node N4 and a cathode coupled to the converter access node Nb.

A duty ratio of the full bridge switching unit 21 may be adjusted to a predetermined value, e.g., 0.5. The first switch Q1 and the second switch Q2 may be simultaneously turned ON/OFF. The third switch Q3 and the fourth switch Q4 may be simultaneously turned ON/OFF. When the first switch Q1 and the second switch Q2 are turned ON, the third switch Q3 and the fourth switch Q4 may be turned OFF. When the first switch Q1 and the second switch Q2 are turned OFF, the third switch Q3 and the fourth switch Q4 may be turned ON. When the duty ratio is adjusted to 0.5, a turn-ON period for the first switch Q1 and the second switch Q2 may be adjusted to be the same as a turn-ON period for the third switch Q3 and the fourth switch Q4.

As the duty ratio of the full bridge switching unit 21 is maintained at 0.5, a circulating current of the transformer 22 and the switches Q1 through Q4 may be maintained small, thereby minimizing loss due to the circulating current. The duty ratio may be adjusted to a value different from 0.5 in another embodiment.

The full bridge switching unit 21 may perform soft switching as the full bridge switching unit 21 performs zero voltage switching (ZVS) turn OFF or zero current switching (ZCS) turn ON, depending, for example, on an adjusted leakage inductance value of the transformer 22.

When the full bridge switching unit 21 performs soft switching, the switching frequency may increase, and accordingly, a filter may decrease in size, thereby making miniaturization and weight reduction possible. Also, the loss occurring during switching is reduced and may even reach 0. Switching devices Q1 through Q4 may be coupled to a booster circuit 30 and may perform ZVS or ZCS.

Referring to FIG. 5 again, the boost converter 30 may include a first inductor Ldc coupled between the converter access node Nb and the snubber access node Ns and a fifth switch Q5 coupled between the snubber access node Ns and the common node Nc. The boost converter 30 may track an output of the solar panel, which changes based on solar irradiance and the temperature transferred from the full bridge unit 20 to the MPP at all times. The boost converter 30 may boost the DC voltage input from the full bridge unit 20 to predetermined DC output voltage.

Current flow, input/output voltage, and output frequency of the boost converter 30 may be adjusted by a duty ratio of the fifth switch Q5. The boost converter 30 may increase output current as short circuit time increases, if the duty ratio increases. The boost converter 30 may decrease the output current as short circuit time decreases, if the duty ratio decreases. In principle, because P=VI, if the output current increases, the voltage decreases. Conversely, if the output current decreases, the voltage increases.

Regarding the full bridge unit 20, in accordance with the present embodiment, a DC link capacitor 50 is not directly connected. As the boost converter 30 is connected, a peak current of the transformer 22 and the full bridge switching unit 21 may be maintained to be small.

In the boost converter 30, a snubber circuit part 40 may be connected. The fifth switch Q5 of the boost converter 30 may be made to be zero voltage turned OFF by the snubber circuit part 40. The snubber circuit part 40 may be coupled at both ends of the boost converter 30, may be a circuit that restricts a forward voltage build-up-rate dv/dt, and may include a capacitor and a resistance.

FIG. 5 illustrates an embodiment of the snubber circuit part 40 which includes a fifth diode D5 coupled between a snubber access node Ns and an inverter access node Nt, a first capacitor C1 and a first resistance R1 coupled in series between the snubber access node Ns and a sixth node N6, a sixth diode D6 coupled between the sixth node N6 and the inverter access node Nt, a seventh diode D7 coupled to the snubber access node Ns and a seventh node N7, and a second capacitor C2 and a second resistance R2 coupled in series between the seventh node N7 and the inverter access node Nt.

The fifth diode D5 has an anode coupled to the snubber access node Ns and a cathode coupled to the inverter access node Nt. The sixth diode D6 has an anode coupled to the sixth node N6 and a cathode coupled to the inverter access node Nt. The seventh diode D7 has a anode coupled to the snubber access node Ns and a cathode coupled to the seventh node N7.

An eighth diode D8 may be coupled between the sixth node N6 and the seventh node N7. The eighth diode D8 has an anode coupled to the seventh node N7 and a cathode coupled to the sixth node N6. The DC link 50 may be a capacitor coupled between the inverter access node Nt and the common node Nc.

FIG. 6 illustrates another embodiment of a circuit of a power conversion apparatus. The circuit of FIG. 6 is the same as the circuit of FIG. 5, except for the full bridge unit 20.

Referring to FIG. 6, the circuit includes a full bridge unit 200 which includes a full bridge switching unit 210 coupled to a solar panel, an LLC resonant circuit 220 to filter high disparity frequency current, a transformer 230 to convert a voltage transferred from the full bridge switching unit 210 and to output the converted voltage, and a diode rectifier 240 coupled to the transformer 230.

The full bridge switching unit 210 may supply DC power supply input from the solar panel to the transformer 230. The full bridge switching unit 210 may supply the DC power supply, so as to allow a current to flow alternatively in both directions of a coil on an input side of the transformer 230.

The full bridge switching unit 210 may include a first switch Q1 coupled between a first output terminal Out1 of the solar panel and a first node N1, a third switch Q3 coupled between the first node N1 and a second output terminal Out2 of the solar panel, a fourth switch Q4 coupled between the second output terminal Out2 of the solar panel and a second node N2, and a second switch Q2 coupled between the second node N2 and the second output terminal OUT2 of the solar panel.

The LLC resonant circuit 220 may include a resonant capacitor, a resonant inductor, and a magnetizing inductor, and may filter high disparity, high frequency current. The LLC resonant circuit 220 may allow, for example, only sine wave current to flow even when a square wave voltage is supplied to the LLC resonant circuit 220.

The LLC resonant circuit 220 may include a resonant inductor Lr, coupled in series between the first node N1 and an eighth node N8 of a transformer 230, and a resonant capacitor Cr and a magnetizing inductance Lm coupled between the eight node N8 and the second node N2.

The resonant capacitor Cr and the resonant inductor may be designed from the following mathematical formula:

$${F}_{sw} = \frac{1}{2 π \sqrt{LrCr}}$$

where F_{sw} is a switching frequency of the full bridge unit 200 implemented as the LLC resonant converter.

As a voltage is supplied to the LLC resonant circuit 220, current flowing at the resonant inductor Lr may be delayed. As a result, soft switching of the full bridge switching unit 210 may be achieved.

A duty ratio of the full bridge switching unit 210 may be adjusted to a predetermined value, e.g., 0.5. The first switch Q1 and the second switch Q2 may be simultaneously turned ON/OFF. The third switch Q3 and the fourth switch Q4 may be simultaneously turned ON/OFF. When the first switch Q1 and the second switch Q2 are turned ON, the third switch Q3 and the fourth switch Q4 may be turned OFF. When the first switch Q1 and the second switch Q2 are turned OFF, the third switch Q3 and the fourth switch Q4 may be turned ON. When the duty ratio is adjusted to 0.5, a turn-ON period for the first switch Q1 and the second switch Q2 may be adjusted to be the same as a turn-ON period for the third switch Q3 and the fourth switch Q4.

As the duty ratio of the full bridge switching unit 210 is maintained at 0.5, a circulating current of the transformer 230 and the switches Q1 through Q4 may be maintained small, thereby minimizing loss due to the circulating current.

The transformer 230 may boost the input DC voltage and may include a first coil and a second coil having a turn ratio of a. The first coil may be accessed between the first node N1 and the second node N2. The second coil may be accessed between the third node N3 and the fourth node N4.

A diode rectifier 240 may rectify boost power supply which is boosted at the transformer 230. The diode rectifier 240 may include a first diode D1 coupled between a converter access node Nb and a third node N3, a third diode D3 coupled between the third node N3 and a common node Nc, a fourth diode D4 coupled between the converter access node Nb and a fourth node N4, a second diode D2 coupled between the fourth node N4 and the common node Nc, and a third capacitor C3 coupled between the converter access node Nb and the common node Nc.

AC current may be rectified by the diode rectifier 240, the rectifying diodes D1, D2, D3, D4 and the third capacitor C3 and DC voltage may be generated.

By way of summation and review, one or more embodiments may provide a solar photovoltaic power conversion apparatus that reduces an amount of circulation current.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A power conversion apparatus, comprising:
a full bridge switching circuit coupled to a solar panel;
a transformer to convert a voltage from the full bridge switching circuit;
a diode rectifier coupled to the transformer; and
a boost converter coupled to the diode rectifier, the boost converter to perform maximum power point tracking of the solar panel, wherein a duty ratio of the full bridge switching circuit is adjusted to be substantially 0.5.

2. The apparatus as claimed in claim 1, wherein the full bridge switching circuit includes:
a first switch coupled between a first output terminal of the solar panel and a first node;
a third switch coupled between the first node and a second output terminal of the solar panel;
a fourth switch coupled between the second output terminal of the solar panel and a second node; and
a second switch coupled between the second node and the second output terminal of the solar panel.

3. The apparatus as claimed in claim 2, wherein the diode rectifier includes:
a first diode coupled between a converter access node and a third node;
a third diode coupled between the third node and a common node;
a fourth diode coupled between the converter access node and a fourth node;
a second diode coupled between the fourth node and the common node.

4. The apparatus as claimed in claim 3, wherein the transformer includes:
a first coil accessed between the first node and the second node, and
a second coil accessed between the third node and the fourth node.

5. The apparatus as claimed in claim 3, wherein the boost converter includes:
a first inductor coupled between the converter access node and a snubber access node; and
a fifth switch coupled between the snubber access node and the common node.

6. The apparatus as claimed in claim 5, further comprising:
a snubber circuit coupled to the boost converter.

7. The apparatus as claimed in claim 6, wherein the snubber circuit includes:
a fifth diode coupled between the snubber access node and an inverter access node;
a first capacitor and a first resistance coupled in series between the snubber access node and a sixth node;
a sixth diode coupled between the sixth node and the inverter access node;
a seventh diode coupled between the snubber access node and a seventh node; and
a second capacitor and a second resistance coupled in series between the seventh node and the inverter access node.

8. The apparatus as claimed in claim 7, wherein the snubber circuit includes an eighth diode coupled between the sixth node and the seventh node.

9. The apparatus as claimed in claim 7, further comprising:
a direct current link coupled between the inverter access node and the common node.

10. The apparatus as claimed in claim 6, wherein the fifth switch is zero voltage turned OFF by the snubber circuit.

11. The apparatus as claimed in claim 3, wherein the common node is coupled to a reference potential.

12. The apparatus as claimed in claim 3, further comprising:
a LLC resonant circuit coupled between the full bridge switching circuit and the transformer.

13. The apparatus as claimed in claim 12, wherein the LLC resonant circuit includes:
a resonant inductor and a resonant capacitor coupled in series between the first node and an eighth node of the transformer; and
a magnetizing inductor coupled between the eighth node and the second node.

14. The apparatus as claimed in claim 13, wherein the diode rectifier includes a third capacitor coupled between the converter access node and the common node.

15. The apparatus as claimed in claim 2, wherein the first switch and the second switch are simultaneously turned ON/OFF, and wherein the third switch and the fourth switch are simultaneously turned ON/OFF.

16. The apparatus as claimed in claim 15, wherein the third switch and the fourth switch are turned OFF when the first switch and the second switch are turned ON, and wherein the third switch and the fourth switch are turned ON when the first switch and the second switch are turned OFF.

17. The apparatus as claimed in claim 15, wherein a turn ON period for the first switch and the second switch is substantially equal to a turn ON period for the third switch and the fourth switch.

18. The apparatus as claimed in claim 1, further comprising an inverter coupled to a DC link.

19. A power conversion apparatus, comprising:
a switching circuit coupled to a renewable energy source;
a transformer to convert a voltage from the switching circuit;
a rectifier to rectify the converted voltage from the transformer;
a boost converter coupled to the rectifier and to perform maximum power point tracking of the renewable energy source; and
a capacitor coupled between the boost converter and an inverter, wherein a duty ratio of the switching circuit is adjusted to be a predetermined value.

20. The power conversion apparatus as claimed in claim 19, wherein the predetermined value is substantially 0.5.
